(19) United States
(12) Patent Application Publication
(10) Pub. No.: US 2006/0138758 A1
(43) Pub. Date: Jun. 29, 2006

(54) Device for controlling a retaining system

(76) Inventors: Michael Roelleke, Leonberg-Hoefingen (DE); Marc Theisen, Besigheim (DE)

Correspondence Address: KENYON & KENYON LLP, ONE BROADWAY, NEW YORK, NY, 10004, US

(21) Appl. No.: 10/529,419

(22) PCT Filed: May 20, 2003
(86) PCT No.: PCT/DE03/01773

§ 371 Date: Nov. 28, 2005

(30) Foreign Application Priority Data
Oct. 8, 2002 (DE) 102 46 800.1

(51) Int. Cl. B60R 21/0132

(52) U.S. Cl. 280/735; 701/45

(57) ABSTRACT

A device is provided for triggering a restraint means, e.g., a two-stage deployment airbag, the device triggering a second airbag stage as a function of a criterion, derived from the acceleration signal, and the closing velocity. The criterion is, in particular, the deployment time for the first airbag stage. As a function of the deployment time of the first airbag stage and the closing velocity, triggering classes are established which in turn define the deployment time for the second airbag stage.

### FIELD OF THE INVENTION

The present invention relates to a device for triggering a restraint system in a vehicle.

### BACKGROUND INFORMATION

Published German patent document DE 199 09 538 discloses deploying the second airbag stage as a function of a criterion derived from the acceleration signal. Published German patent document DE 101 09 043 describes triggering the second airbag stage as a function of two criteria derived from the acceleration signal.

### SUMMARY

In contrast, the device of the present invention for triggering a restraint system has the advantage that the second airbag stage is triggered on the basis of the closing velocity (i.e., crash velocity), which is determined using a precrash sensor system, and the deployment time of the first airbag stage. This has the advantage that the deployment time for the second airbag stage may be determined exactly.

It is particularly advantageous that the at least one criterion, ascertained through a variable derived from the acceleration signal, is the deployment time for the first airbag stage. Consequently, the second airbag stage is then determined as a function of the deployment time for the first airbag stage and the closing velocity. The deployment of the second stage is therefore calculated from that of the first stage plus the delay to be computed. To ascertain this delay, at least one class can be defined as a function of the deployment time of the first stage and the closing velocity. The classes describe the different delays. This method offers the advantage that only that threshold-value function must be set which is necessary for deploying the first airbag stage. This reduces development expenditure. In addition, computing power is saved, since after the first stage is deployed, no further signal processing is necessary for deploying the second stage. This saved computing power may then be made available for deploying other restraint means. An important advantage is that the second airbag stage may be deployed precisely in relation to the first airbag stage. That is to say, both the minimum delay necessary, for example, for the deployment technique, and the maximum delay for the effective protection of the passengers may be adhered to precisely, since two threshold-value functions that are independent of each other are no longer used. It is also advantageous that the second airbag stage is never triggered at a closing velocity below a certain limit, e.g., 29 km/h. Thus, it is possible to fulfill the precise differentiation between the deployment of the first and the second stage necessary for the American legislation (FMVSS 208).

The lower limit is an empirical limiting value which indicates a lesser crash severity, so that the restraint force by the second airbag stage is not necessary here. Finally, it is also advantageous that the device defines at least three triggering classes which are defined as a function of the closing velocity and the deployment time for the first airbag stage.

### BRIEF DESCRIPTION OF THE DRAWINGS

FIG. 1 shows a block diagram of the device according to the present invention.

FIG. 2 shows a flowchart of a first example method according to the present invention.

FIG. 3 shows a flowchart of a second example method according to the present invention.

FIG. 4 shows a flowchart of a third example method according to the present invention.

FIG. 5 shows a flowchart of a fourth example method according to the present invention.

FIG. 6 shows a graph illustrating different classes for triggering the second stage of airbag deployment.

### DETAILED DESCRIPTION

The device according to the present invention enables a precise deployment of the second airbag stage. To this end, the deployment time for the second airbag stage is determined as a function of a criterion, which is derived from the acceleration signal, and the closing velocity which is ascertained by a precrash sensor. The deployment time for the first airbag stage is used here as the criterion.

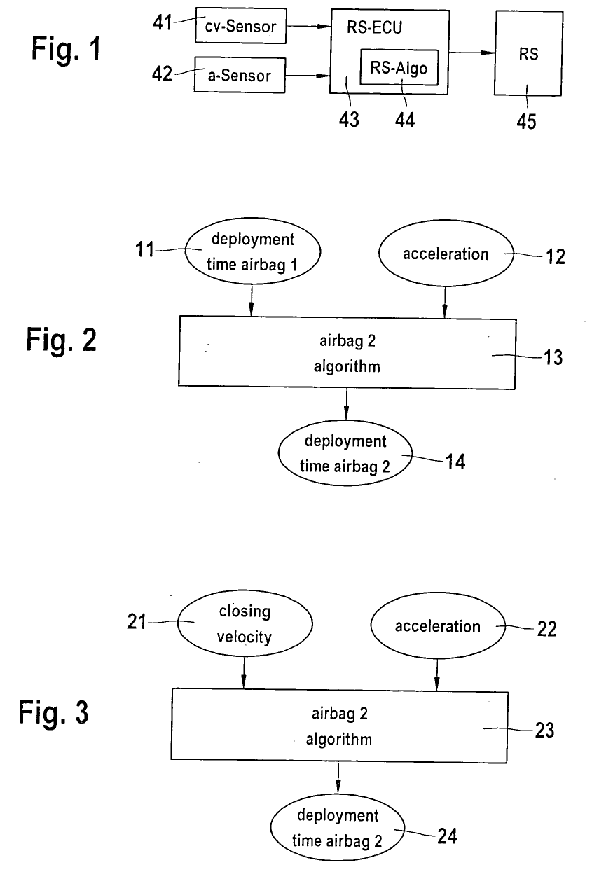

FIG. 1 shows the device according to the present invention in a block diagram. An acceleration sensor 42 is connected to a first data input of a control unit 43. A precrash sensor 41 for ascertaining the closing velocity is connected to a second data input of control unit 43. The algorithm for a restraint system 45, which here triggers a two-stage airbag, runs on a processor 44 in control unit 43. Control unit 43 is connected via a data output to restraint system 45, here, for example, to a two-stage airbag. However, it is clear that there are at least two two-stage airbags in restraint system 45 in a vehicle, one for the driver and one for the front-seat passenger. Further restraint means such as seat-belt pretensioners, or single-stage or multi-stage airbags are not shown here for the sake of simplicity.

Acceleration sensor 42 may be situated in control unit 43 or else mounted externally as a so-called satellite or peripheral acceleration sensor such as an upfront sensor or a side-impact sensor. Precrash sensor 41 is usually remote from control unit 43 and may take the form of a radar, ultrasound or video sensor for monitoring the surrounding field. Sensors 41 and 42 may be equipped with a signal-processing unit, and therefore already preprocess the ascertained measured values. The connection in control unit 43 may be implemented via a bus or via individual two-wire lines which are either uni-directional or bi-directional. Generally, only one uni-directional connection is necessary from sensor 41 or 42 to control unit 43. However, a bi-directional connection may also be useful for testing the individual sensors. Sensors additional to the sensors 41 and 42 shown here can be connected to control unit 43.

FIG. 2 shows the first method according to the present invention. In the first method, the calculation of the deployment time of second stage 14 is based on the deployment time of first stage 11 and the further pattern of acceleration signal 12. If, for example, the first stage is deployed very early, the second stage is deployed with minimal delay, since in this case one must assume a very hard crash. If the first stage is first deployed later, then the acceleration signal must be observed further to decide whether it is a crash of such severity that the second stage must be deployed.

FIG. 3 shows a second method according to the present invention. In the second variant, both acceleration signal 22 and closing velocity 21 are evaluated. In this context, the acceleration signal is processed. This may be, for example, a simple or double integration. The variable thus obtained is compared to a threshold which may be a function both of time and of velocity. If the threshold is exceeded, the second airbag stage is deployed.

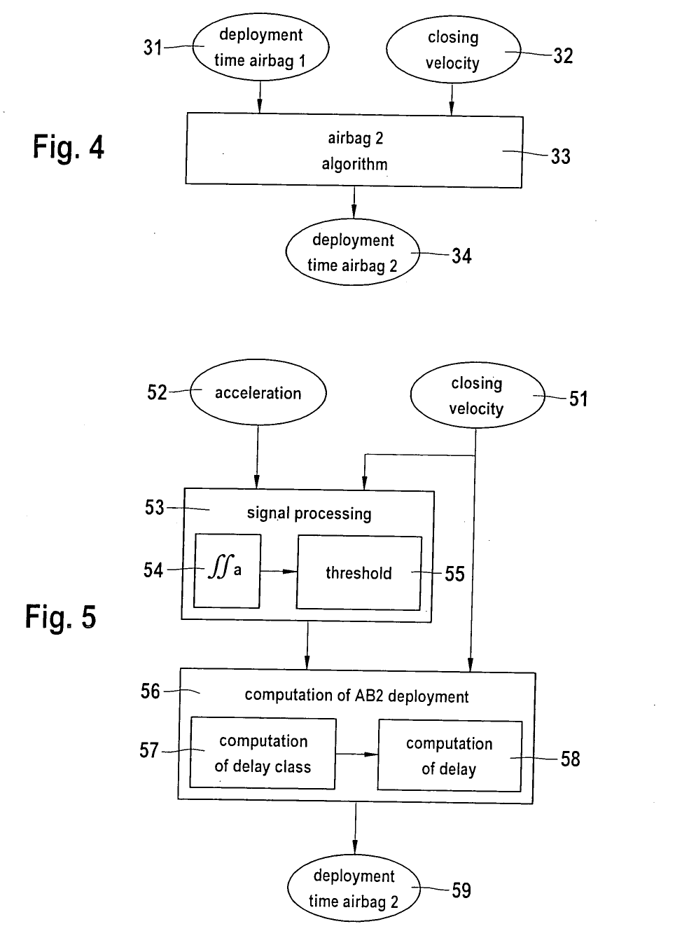

FIG. 4 shows a flowchart of an example method which is executed in the device according to the present invention. The deployment time for first airbag stage 31 was already calculated by processor 44 using a signal from acceleration sensor 42. In addition, at this point, precrash sensor 41 has determined closing velocity 32. These two parameters enter into deployment algorithm 33 which is computed by processor 44. The result is the deployment time for the second airbag stage. It is labeled by reference numeral 34.

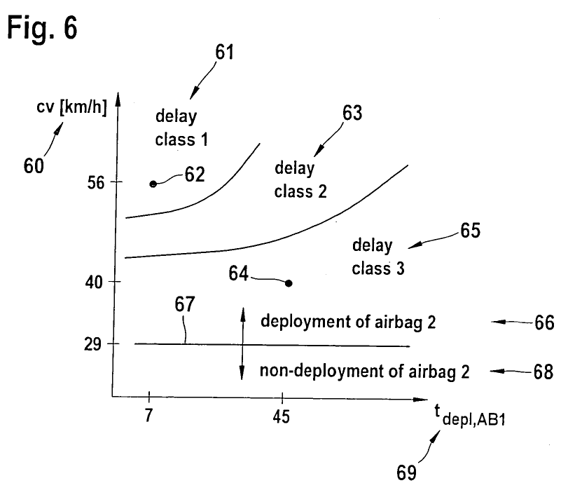

As FIG. 5 shows that, in addition to closing velocity 51, acceleration signal 52 determined by acceleration sensor 42 is used as an input parameter in the algorithm. This algorithm is processed in control unit 43. From these two parameters, in an algorithm (not further discussed here), with the aid of a signal processing 53, the deployment decision for the airbag with regard to the first stage is initially ascertained. For example, this may be accomplished either directly from the acceleration signal or via the velocity signal calculated by simple integration, or via forward-displacement signal 54 ascertained by double integration, by a threshold-value comparison 55. In this context, closing velocity 51 of precrash sensor 41 is also taken into account. In second step 56, from the deployment time for the airbag with respect to the first stage and from the closing velocity, the deployment decision is then calculated for the airbag in regard to the second stage. This is again carried out in two steps. To that end, first of all delay class, in step 57, and therefore then in the second step 58, delay itself is ascertained. The deployment of the second stage occurs in step 59. The definition of a delay class is clarified in FIG. 6. Here, closing velocity 60 is plotted over the deployment time of the airbag of first stage 69. For example, if the closing velocity is less than e.g., 29 km/h, as shown by reference 67, then the airbag of the second stage must not be deployed. This is the case 68. If the velocity is above this limit, the second stage must be deployed with a certain delay. This is found in class 65. Here, for example, this applies to value pair 64. The delay may either be fixed or a function of the crash severity.

If, for example, the closing velocity is high, e.g., approximately 56 km/h, and the deployment time for the airbag of the first stage is very low, e.g., 8 ms, then one may assume a very severe crash—this pertains to value pair 62—and the second stage must be deployed with a small delay. This then pertains to all value pairs for class 61. In the case of a slower crash, e.g., 40 km/h, with a later deployment time of the airbag with respect to the first stage, e.g., 45 ms—this pertains to the case of value pair 64 addressed above—the airbag must be deployed with a longer delay. Crash situations in which the deployment of the second stage is delayed according to the same rule are combined to form delay classes.

Three such delay classes 61, 63, 65 are shown in FIG. 6. However, to be delayed according to the same rule can also mean, for instance, that the delay time increases in linear fashion with the deployment time of the first stage or with the closing velocity. The separating lines between the individual delay classes may be established, for example, using a mathematical function or via a polyline defined by interpolation points. The number of delay classes can be a matter of choice, but at least one, so that in the simplest case, differentiation is only made between deployment and non-deployment.

Thus, given knowledge of the closing velocity and the deployment time of the first stage of the airbag, this method according to the present invention makes it possible to precisely ascertain the delay until the deployment of the second airbag stage.

1-5. (canceled)

6. A system for triggering a restraint system in a vehicle, comprising:
at least one acceleration sensor for measuring an acceleration of the vehicle and generating a corresponding acceleration signal;
a pre-crash sensor for determining a closing velocity of the vehicle in a crash;
a control arrangement for triggering the restraint system in a crash of the vehicle, wherein the restraint system is an airbag with at least a first stage and a second stage of deployment, and wherein triggering of at least the first stage of deployment of the airbag is determined as a function of at least one criterion derived from the acceleration signal, and wherein triggering of the second stage of deployment of the airbag is determined as a function of a combination of the at least one criterion and the closing velocity.

7. The device as recited in claim 6, wherein the at least one criterion is a time of deployment for the first stage of airbag deployment.

8. The device as recited in claim 7, wherein one of a plurality of categories is defined as a function of the time of deployment for the first stage of airbag deployment and the closing velocity, and wherein a time of deployment for the second stage of airbag deployment is determined as a function of the defined category.

9. The device as recited in claim 8, wherein the second stage of deployment of the airbag is not triggered if the closing velocity is below a predetermined threshold.

10. The device as recited in claim 8, wherein the plurality of categories include a first category corresponding to deployment of the second stage and a second category corresponding to non-deployment of the second stage.
